(19) United States
(12) Patent Application Publication
(10) Pub. No.: US 2014/0062639 A1
(43) Pub. Date: Mar. 6, 2014

(54) Surface-Mount Inductor

(71) Applicants: Kunio Sasamori, Higashimatsuyama-shi (JP); Masaaki Totsuka, Tsurugashima-shi (JP); Yasuyuki Kawauchi, Tsurugashima-shi (JP); Keita Muneuchi, Shiki-shi (JP); Hiroyasu Mori, Kawagoe-shi (JP)

(72) Inventors: Kunio Sasamori, Higashimatsuyama-shi (JP); Masaaki Totsuka, Tsurugashima-shi (JP); Yasuyuki Kawauchi, Tsurugashima-shi (JP); Keita Muneuchi, Shiki-shi (JP); Hiroyasu Mori, Kawagoe-shi (JP)

(73) Assignee: TOKO, INC., Tsurugashima-shi (JP)

(21) Appl. No.: 14/019,112

(22) Filed: Sep. 5, 2013

(30) Foreign Application Priority Data
Sep. 6, 2012 (JP) 2012-195826

(51) Int. Cl. H01F 3/08

(52) U.S. Cl. CPC H01F 3/08
USPC 336/175

(57) ABSTRACT

[TECHNICAL PROBLEM]

Present invention provides a surface-mount inductor allowing the Q to be improved at a higher frequency and preventing the efficiency of the inductor from getting worse even at the higher frequency.

[SOLUTION TO THE PROBLEM]

A surface-mount inductor comprises: a coil formed by winding a conductive wire; and a core comprising mainly of a magnetic powder and a resin and containing the coil therein. The magnetic powder contains plural types of magnetic powders each having a different particle size from others, and the plural types of magnetic powders are mixed to satisfy the following relationship: Σan·Φn≦10 μm, where an is a mixing ratio, Φn is an average particle size, and n is an integer of 2 or more.

### TECHNICAL FIELD

The present invention relates to a surface-mount inductor comprising: a coil formed by winding a conductive wire; and a core comprising of a magnetic powder and a resin and containing the coil therein.

### BACKGROUND ART

A conventional surface-mount inductor includes a type, as illustrated in FIG. 2, which is obtained by: winding a conductive wire to form a coil 31, and forming a core 32 using a composite material of a metal magnetic powder and a resin while allowing the coil 31 to be incorporated in the core 32 (see JP 2010-245473A). External terminals 33 are formed on the surface of the core 32, and the coil 31 is connected between the external terminals 33.

Since this type of surface-mount inductor uses a metal magnetic material, the coil can be disposed in a high magnetic permeability material to have an improved DC superimposition characteristic. Therefore, this type of surface-mount inductor is used, for example, for an inductor or a transformer for a power circuit or a DC/DC converter through which a large electric current flows.

### SUMMARY OF THE INVENTION

### Technical Problem

In recent years, in a power circuit or a DC/DC converter circuit for which this type of surface-mount inductor is used, an operation signal tends to have higher frequency from 1-4 MHz at present to 6-10 MHz.

In such a situation, there is a problem with the conventional surface-mount inductor that a frequency at which Q of the metal magnetic material reaches a peak is no more than 0.5 MHz, and efficiency of the inductor becomes worse when the frequency exceeds 1 MHz.

It is therefore an object of the present invention to provide a surface-mount inductor allowing the Q to be improved at a higher frequency and preventing the efficiency of the inductor from getting worse even at the higher frequency.

### Solution to the Problem

The present invention provides a surface-mount inductor comprising: a coil formed by winding a conductive wire; and a core comprising mainly of a magnetic powder and a resin and containing the coil therein, wherein the magnetic powder contains plural types of magnetic powders each having a different particle size from others, and the plural types of magnetic powders are mixed to satisfy the following relationship: Σan·Φn≦10 μm, where an is a mixing ratio, Φn is an average particle size, and n is an integer of 2 or more.

The present invention also provides a surface-mount inductor comprising: a coil formed by winding a conductive wire; and a core comprising mainly of a magnetic powder and a resin and containing the coil therein, wherein the magnetic powder contains two types of magnetic powders each having a different particle size from the other, and the two types of magnetic powders are mixed to satisfy the following relationship: a×Φ1+(1−a)×Φ2≦10 μm, where Φ1 is a particle size of a first magnetic powder, Φ2 is a particle size of a second magnetic powder, and a is a mixing ratio.

### Effect of the Invention

According to the surface-mount inductor of the present invention, the magnetic powder constituting a core containing a coil therein contains plural types of magnetic powders each having a different particle size from others, and the plural types of magnetic powders are mixed to satisfy the following relationship: Σan·Φn≦10 μm, where an is a mixing ratio, Φn is an average particle size, and n is an integer of 2 or more. This makes it possible to allow Q to be improved at a higher frequency and prevent the efficiency of the inductor from getting worse even at the higher frequency.

Further, according to the surface-mount inductor of the present invention, the magnetic powder constituting a core containing a coil therein contains two types of magnetic powders each having a different particle size from the other, and the two types of magnetic powders are mixed to satisfy the following relationship: a×Φ1+(1−a)×Φ2≦10 μm, where Φ1 is a particle size of a first magnetic powder, Φ2 is a particle size of a second magnetic powder, and a is a mixing ratio. This makes it possible to allow Q to be improved at a higher frequency and prevent the efficiency of the inductor from getting worse even at the higher frequency.

### BRIEF DESCRIPTION OF THE DRAWINGS

FIG. 1 is a perspective view illustrating an embodiment of a surface-mount inductor according to the present invention.

FIG. 2 is a perspective view illustrating a conventional surface-mount inductor.

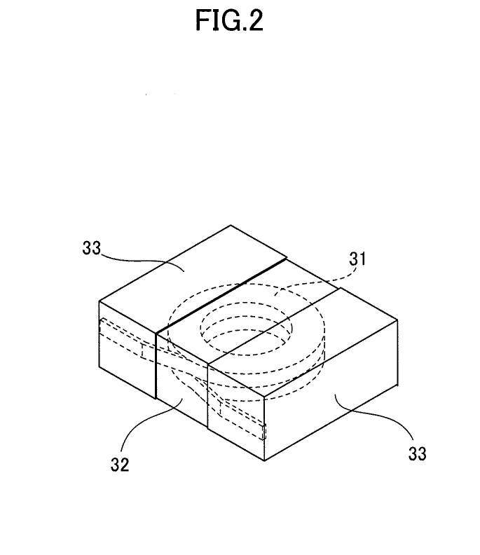

### DESCRIPTION OF EMBODIMENTS

A surface-mount inductor of the present invention comprises: a coil formed by winding a conductive wire; and a core comprising mainly of a magnetic powder and a resin and containing the coil therein. The magnetic powder contains two types of metal magnetic powders each having a different particle size from the other. The two types of metal magnetic powders are mixed to satisfy the following relationship: a×Φ1+(1−a)×Φ2≦10 μm, where Φ1 is a particle size of a first magnetic powder, Φ2 is a particle size of a second magnetic powder, and a is a mixing ratio.

Thus, this surface-mount inductor makes it possible to allow a frequency at which Q of the metal magnetic material reaches a peak to be shifted to the higher frequency side and also allow an AC resistance to be decreased, without reducing magnetic permeability.

### Embodiment

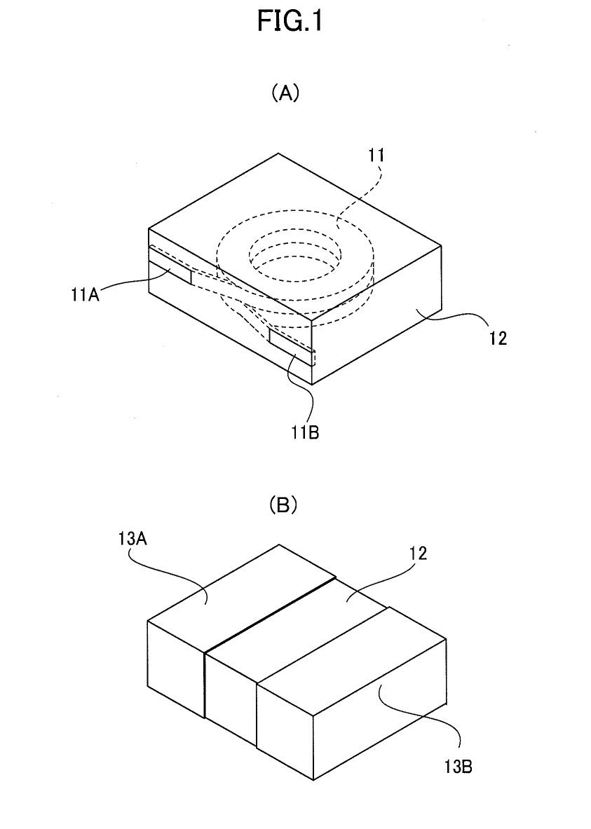

An embodiment of the surface-mount inductor according to the present invention will now be described with reference to FIG. 1.

FIG. 1 is a perspective view illustrating an embodiment of a surface-mount inductor according to the present invention.

In FIG. 1, the reference numeral 11 designates a coil, and 12 designates a core.

The coil 11 is formed by winding a conductive wire in two tiers to allow its opposite ends 11A, 11B to be positioned on an outer periphery. For the conductive wire, a rectangular wire applied with an insulating coating is used.

The core 12 consists mainly of a magnetic powder and a resin, where the magnetic powder is formed of a composite material containing two types of metal magnetic powders each having a different particle size from the other. For the two types of metal magnetic powders, an amorphous alloy powder is used. In this case, the two types of metal magnetic powders are mixed to satisfy the following relationship: a×Φ1+(1−a)×Φ2≦10 μm, where Φ1 is a particle size of a first metal magnetic powder, Φ2 is a particle size of a second metal magnetic powder, and a is a mixing ratio. For the resin, an epoxy resin is used. The coil 11 is embedded within the core 12. The surfaces of the opposite ends 11A, 11B of the coil 11 are exposed on the same side surface of the core 12. From the surfaces of the opposite ends 11A, 11B of the coil 11 exposed on the side surface of the core 12, the insulating coating is stripped to allow an electrical conductor to be exposed.

Then, external electrodes 13A, 13B are formed on end surfaces and four side surfaces of the core 12. The external electrode 13A and the end 11A of the coil 11, as well as the external electrode 13B and the end 11B of the coil 11 are connected respectively, to connect the coil 11 between the external electrodes 13A and 13B.

This surface-mount inductor is produced in the following manner. Firstly, two tablets are formed with one having a flat-plate shape and the other having a flat-plate shape with columnar convex portion provided around the peripheral edge thereof, by a composite material containing mainly two types of amorphous alloy powders each having a different particle size from the other and an epoxy resin, wherein the two types of amorphous alloy powders are mixed to satisfy the following relationship: a×Φ1+(1−a)×Φ2≦10 μm, where Φ1 is a particle size of a first amorphous alloy powder, Φ2 is a particle size of a second amorphous alloy powder, and a is a mixing ratio.

Then, the coil 11 is mounted on the tablet having a flat-plate shape with columnar convex portion provided around the peripheral edge thereof, which is then disposed in a mold with the opposite ends 11A, 11B of the coil being positioned along an outer side surface of the columnar convex portion of the tablet. In this case, the opposite ends 11A, 11B of the coil are positioned to be sandwiched between the outer side surface of the columnar convex portion of the tablet and an inner wall surface of the mold.

Subsequently, the tablet having a flat-plate shape is mounted on the tablet having a flat-plate shape with columnar convex portion provided around the peripheral edge thereof and the coil disposed in the mold. Using this mold, the tablets and the coil are pressurized while heated to a temperature at which a composite material constituting the tablets is softened to integrate the coil and two tablets together and the tablets are cured to form the core 12.

Further, the core 12 containing the coil 11 placed in the mold is ejected and an electrically-conductive paste is applied on the end surfaces and four side surfaces of the core 12 to form the external electrodes 13A, 13B.

In this surface-mount inductor, when an amorphous alloy powder having a particle size of 10 μm and a magnetic permeability of 18.9 and an amorphous alloy powder having a particle size of 5 μm and a magnetic permeability of 12.7 were used for the magnetic powder constituting the core and the ratio thereof was changed, then a magnetic permeability, an average particle size, and a frequency at which Q reaches a peak were altered as illustrated in Table 1.

TABLE 1

| | | Average particle | Q |
|---|---|---|---|
| Ratio | μ | size (μm) | (MHz) |
| 10:0 | 18.9 | 10 | 1 |
| 9:1 | 19.4 | 9.5 | 1 |
| 8:2 | 19.4 | 9 | 1 |
| 7:3 | 19.2 | 8.5 | 1 |
| 6:4 | 18.7 | 8 | 1.3 |
| 5:5 | 17.4 | 7.5 | 1.3 |
| 4:6 | 16.5 | 7 | 1.8 |
| 0:10 | 12.7 | 5 | 3.5 |

In this surface-mount inductor, when the above amorphous alloy powders were mixed to satisfy the following relationship: a×Φ1+(1·a)×10 μm, where Φ1 is a particle size of a first amorphous alloy powder, Φ2 is a particle size of a second amorphous alloy powder, and a is a mixing ratio, then the frequency at which Q reaches a peak could be 1 MHz or more relative to the fact that in the conventional surface-mount inductor, the average particle size was 24 μm and the frequency at which Q reaches a peak was 0.5 MHz.

Further, in this surface-mount inductor, when the ratio of addition of the amorphous alloy powder having a particle size of 5 μm is set to 4 or more under the condition of a×Φ1+(1−a)×Φ2=10 μm, where Φ1 is a particle size of the first amorphous alloy powder, Φ2 is a particle size of the second amorphous alloy powder, then the frequency at which Q reaches a peak could be 1.3 MHz or more, but the magnetic permeability was decreased below that of the amorphous alloy powder having a particle size of 10 μm.

Moreover, in this surface-mount inductor, when the ratio of addition of the amorphous alloy powder having a particle size of 5 μm is set to less than 4 under the condition of a×Φ1+(1−a)×Φ2=10 μm, where Φ1 is a particle size of the first amorphous alloy powder, Φ2 is a particle size of the second amorphous alloy powder, then the frequency at which Q reaches a peak was 1 MHz, but the magnetic permeability was increased above that of the amorphous alloy powder having a particle size of 10 μm.

Thus, this surface-mount inductor could achieve a higher frequency at which Q reaches a peak without decreasing the magnetic permeability by mixing the first amorphous alloy powder and the second amorphous alloy powder having a particle size smaller than that of the first amorphous alloy powder to satisfy the following relationship: a×Φ1+(1−a)×Φ2=10 μm and by making the ratio thereof to be 7:3 to 9:1, where Φ1 is a particle size of the first amorphous alloy powder, Φ2 is a particle size of the second amorphous alloy powder, and a is a mixing ratio.

While an embodiment of a method of producing a surface-mount inductor according to the present invention has been described above, the invention is not limited to this embodiment. For example, a use case of two types of metal magnetic powders are described in the above embodiment. Alternatively, three types or more of metal magnetic powders may be applicable. In this case, plural types of magnetic powders are mixed to satisfy the following relationship: Σan·Φn≦10 μm, where an is a mixing ratio, Φn is an average particle size, and n is an integer of 2 or more. In addition, an amorphous alloy powder is used as the magnetic powder in the above embodiment. Alternatively, a magnetic powder with various compositions such as a silicon chrome alloy powder may be used.

Further, magnetic powders with different magnetic permeabilities may be used as the plural types of magnetic powders.

Furthermore, for the resin constituting the core, resins with various compositions other than the epoxy resin may be used.

### EXPLANATION OF CODES

11: coil
12: core

What is claimed is:

1. A surface-mount inductor comprising: a coil formed by winding a conductive wire; and a core comprising mainly of a magnetic powder and a resin and containing the coil therein,
wherein the magnetic powder contains plural types of magnetic powders each having a different particle size from others, and the plural types of magnetic powders are mixed to satisfy the following relationship: Σan·Φn≦10 μm, where an is a mixing ratio, Φn is an average particle size, and n is an integer of 2 or more.

2. A surface-mount inductor comprising: a coil formed by winding a conductive wire; and a core comprising mainly of a magnetic powder and a resin and containing the coil therein,
wherein the magnetic powder contains two types of magnetic powders each having a different particle size from the other, and the two types of magnetic powders are mixed to satisfy the following relationship: a×Φ1+(1−a)×Φ2≦10 μm, where Φ1 is a particle size of a first magnetic powder, Φ2 is a particle size of a second magnetic powder, and a is a mixing ratio.

3. The surface-mount inductor as defined in claim 2, wherein the first and second magnetic powders are mixed to satisfy the following relationship: a×Φ1+(1−a)×Φ2=10 μm, and the ratio is 7:3 to 9:1.

4. The surface-mount inductor as defined in claim 2, wherein the first and second magnetic powders have different magnetic permeabilities.

5. The surface-mount inductor as defined in claim 1, wherein the magnetic powder is an amorphous alloy.

6. The surface-mount inductor as defined in claim 2, wherein the magnetic powder is an amorphous alloy.
